(19) United States
(12) Patent Application Publication
(10) Pub. No.: US 2023/0078349 A1
(43) Pub. Date: Mar. 16, 2023

(54) Automated Cutting Die Being Produced Edible Biodegradable Tableware

(71) Applicant: Zhi-Cong Kong, Foshan City (CN)

(72) Inventor: Zhi-Cong Kong, Foshan City (CN)

(21) Appl. No.: 17/471,377

(22) Filed: Sep. 10, 2021

(51) Int. Cl. A21C 11/10; A23P 30/10

(52) U.S. Cl. CPC A21C 11/10; A23P 30/10; A47G 2400/105; A47G 21/023

(57) ABSTRACT

An automated cutting die being produced edible biodegradable tableware contains: a cutting assembly, a holding assembly, and edible biodegradable dough. The cutting assembly includes a first cutting mold and a second cutting mold. The first cutting mold has multiple cutting portions, and the second cutting mold has multiple grooves and two first support portions. The holding assembly includes a first receiving mold and a second receiving mold. The first receiving mold has multiple pressing portions, two second support portions formed beside the multiple pressing portions, and multiple through holes defined on the multiple pressing portions, wherein the second receiving mold has a recessed portion defined thereon, a molding cavity formed in a hollow shape beside the recessed portion and multiple passing orifices defined on the molding cavity.

### BACKGROUND OF THE INVENTION

### Field of the Invention

The present invention relates to a cutting die, and more particularly to an automated cutting die which is produced edible biodegradable tableware.

### Description of the Prior Art

In order to save tableware cost, many catering businesses or consumers usually choose to buy disposable tableware. Disposable tableware is usually made of plastic or paper. Compared with reusable tableware, disposable tableware has the effect of saving washing tableware and reducing purchase cost. However, the materials made of disposable tableware cannot be biodegraded, so the disposable tableware will not rot, and the problem of garbage accumulation occurs likely. Moreover, the waste formed by the used disposable tableware will be treated by incineration and landfill methods. It will cause serious environmental pollution, and it is extremely difficult to recycle the disposable tableware, thus leading to serious ecological damage and garbage hazards.

At present, 300 million tons of plastic are produced every year in the world, 50% of which are disposable. Poor downstream processing of disposable plastics has caused 8.3 million tons of plastic to flow into the ocean, and 50% of marine debris is disposable plastics. Among all kinds of marine plastic waste, waste plastic tableware ranks among the top 10 in various marine plastic wastes. A large number of plastic particles float in the ocean and cause marine organisms to eat by mistake. For example, in the North Pacific, 120,000 to 140,000 tons of plastic are eaten by fish every year. According to the current trend toward the index of plastic waste accumulated in the ocean, scientists predict that by 2050, the weight of plastic waste in the ocean will be heavier than the weight of fish.

Currently, alternative petroleum-based plastics are mainly bio-based plastics. The most representative one is polylactic acid (PLA), but the fully degradable bioplastics are polyhydroxybutyrate (PHB) and tert-butyl dimethyl ester in the form of film. Silicon-based (TBS), and the conversion rate of substances in organic chemistry is not high.

In addition, there are fiber products such as bamboo/wood/palm, but a lot of polluting wastewater will be generated during upstream processing, and the automation rate and yield during processing are also problems.

Therefore, there is no tableware in the industry that can be completely degraded in various environments including the wild, and there is no cutting die that can fully automate the production of tableware and can be degraded in a natural environment.

The present invention has arisen to mitigate and/or obviate the afore-described disadvantages.

### SUMMARY OF THE INVENTION

The primary object of the present invention is to provide an automated cutting die which contains a cutting assembly, a holding assembly, and edible biodegradable dough, wherein the edible biodegradable dough is defined between the cutting assembly and the holding assembly and contacts with the holding assembly or the cutting assembly, such that equipment mates with the automated cutting die to feed, cut, press, and repeating feeding, cutting, and pressing automatically.

Another object of the present invention is to provide an automated cutting die which is capable of producing tableware, such as a knife, a fork, or a soup spoon modularly and automatically.

### BRIEF DESCRIPTION OF THE DRAWINGS

FIG. 1 is a flow chart showing the operation of an automated cutting die being produced edible biodegradable tableware according to the present invention.

FIG. 2 is a perspective view showing the exploded components of the automated cutting die being produced edible biodegradable tableware according to the present invention.

FIG. 3 is another perspective view showing the exploded components of the automated cutting die being produced edible biodegradable tableware according to the present invention.

FIG. 4 is a side plan view showing the operation of the automated cutting die of FIG. 3 according to the present invention.

FIG. 5 is another side plan view showing the operation of the automated cutting die of FIG. 3 according to the present invention.

FIG. 6 is also another side plan view showing the operation of the automated cutting die according to the present invention.

FIG. 7 is a flow chart showing the operation of an automated cutting die being produced edible biodegradable tableware according to a first embodiment of the present invention.

FIG. 8 is a perspective view showing the operation of the automated cutting die being produced edible biodegradable tableware according to the first embodiment of the present invention.

FIG. 9 is another perspective view showing the operation of the automated cutting die being produced edible biodegradable tableware according to the first embodiment of the present invention.

FIG. 10 is also another perspective view showing the operation of the automated cutting die being produced edible biodegradable tableware according to the first embodiment of the present invention.

FIG. 11 is still another perspective view showing the operation of the automated cutting die being produced edible biodegradable tableware according to the first embodiment of the present invention.

FIG. 12 is a flow chart showing the operation of an automated cutting die being produced edible biodegradable tableware according to a second embodiment of the present invention.

FIG. 13 is a perspective view showing the operation of the automated cutting die being produced edible biodegradable tableware according to the second embodiment of the present invention.

FIG. 14 is a side plan view showing the operation of the automated cutting die being produced edible biodegradable tableware according to the second embodiment of the present invention.

FIG. 15 is another side plan view showing the operation of the automated cutting die being produced edible biodegradable tableware according to the second embodiment of the present invention.

FIG. 16 is also another side plan view showing the operation of the automated cutting die being produced edible biodegradable tableware according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

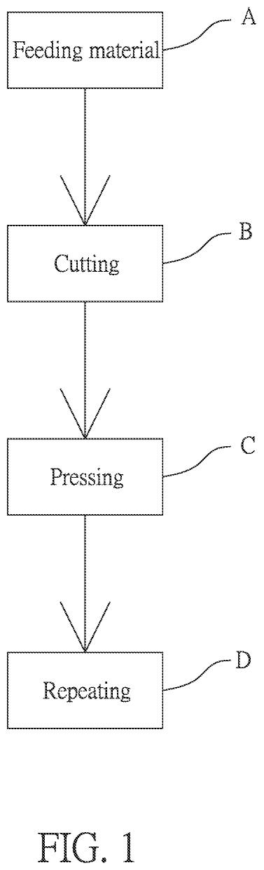

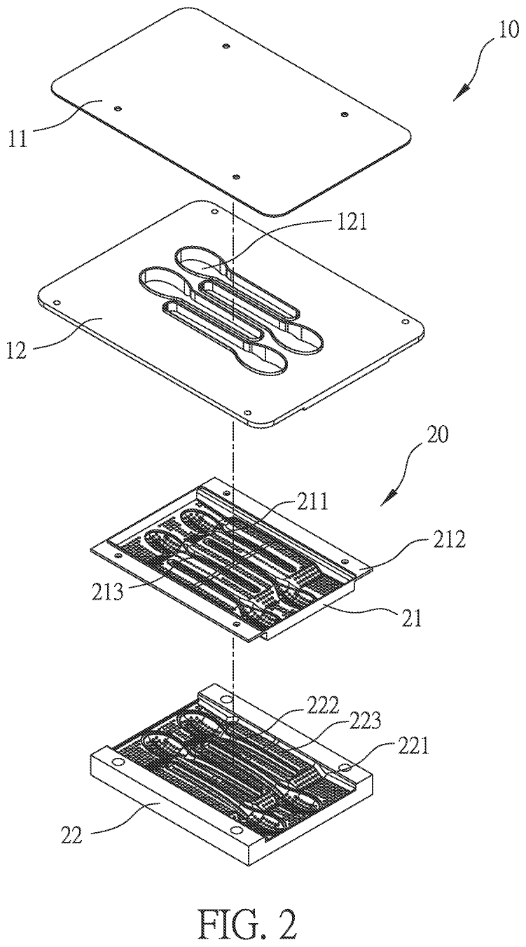

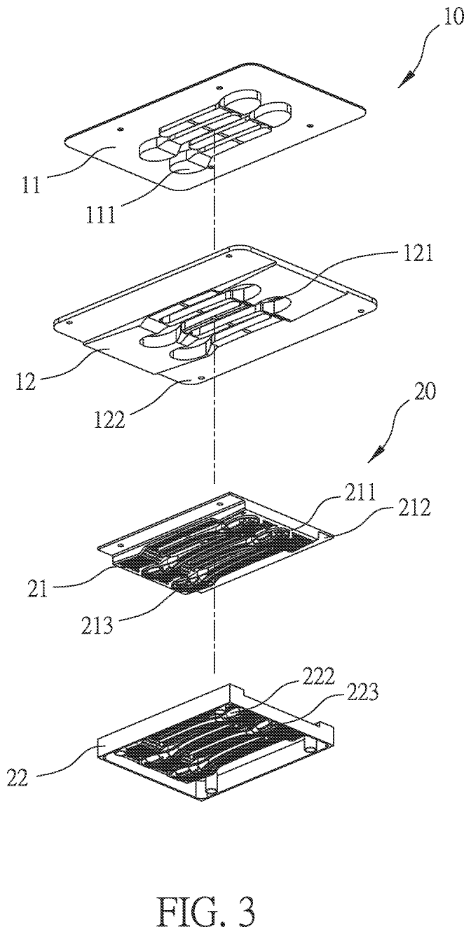

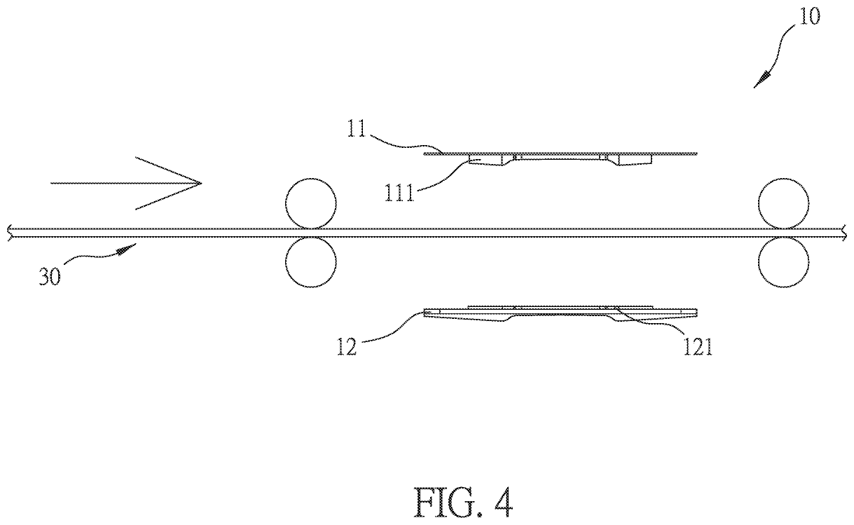

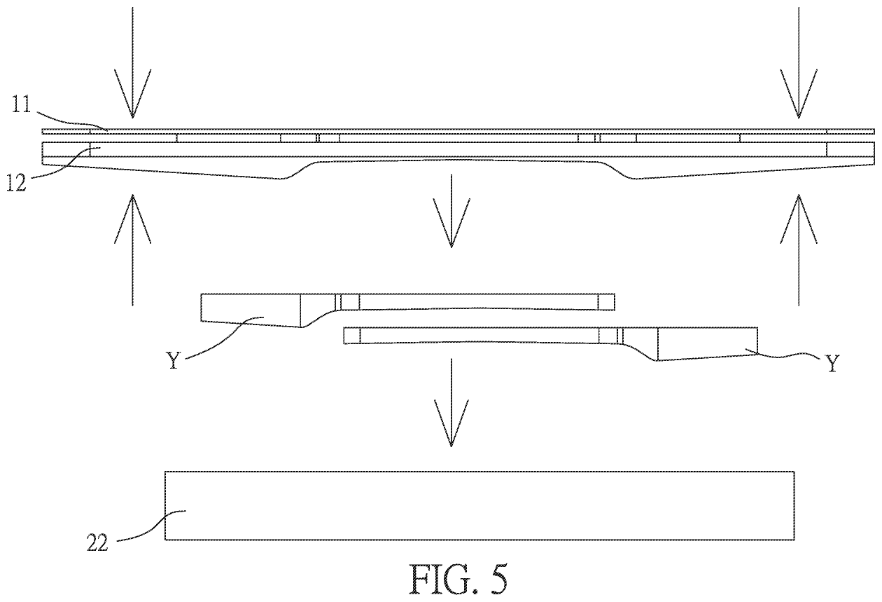

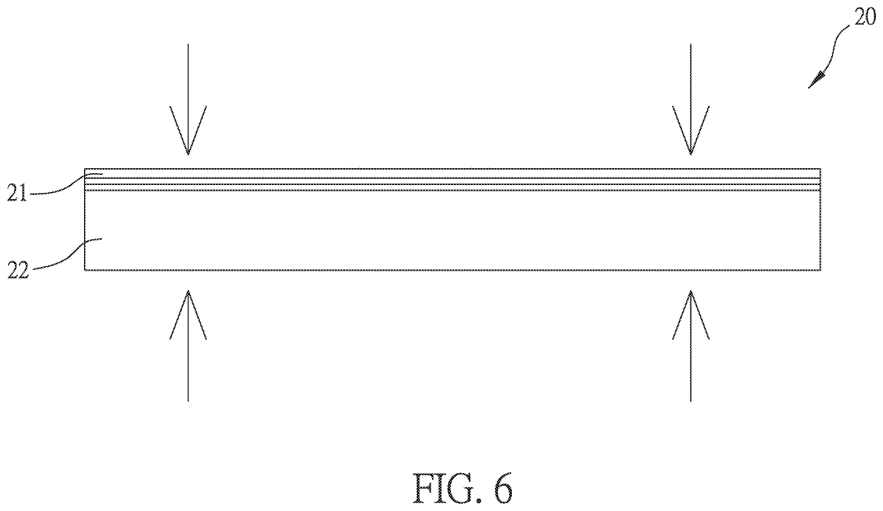

With reference to FIGS. 1-6, an automated cutting die being produced edible biodegradable tableware according to a preferred embodiment of the present invention comprises: a cutting assembly 10, a holding assembly 20, and edible biodegradable dough 30.

The cutting assembly 10 includes a first cutting mold 11 and a second cutting mold 12, wherein a first end of the first cutting mold 11 is arranged on equipment, and the first cutting mold 11 has multiple cutting portions 111 formed on a second end thereof in a tableware shape, such as a knife, a fork, or a soup spoon. The second cutting mold 12 has multiple grooves 121 defined on a middle section thereof and corresponding to the multiple cutting portions 111 of the first cutting mold 11, and the second cutting mold 12 has two first support portions 122 formed beside the multiple grooves 121 and being fixed on the equipment.

The holding assembly 20 includes a first receiving mold 21 and a second receiving mold 22, wherein the first receiving mold 21 has multiple pressing portions 211 corresponding to the multiple grooves 121 of the second cutting mold 12, two second support portions 212 formed beside the multiple pressing portions 211, and multiple through holes 213 defined on the multiple pressing portions 211.

The second receiving mold 22 has a recessed portion 221 defined thereon, a molding cavity 222 formed in a hollow shape beside the recessed portion 221 and multiple passing orifices 223 defined on the molding cavity 222.

Referring to FIG. 1, a method of operating the automated cutting die comprises steps of:

A) feeding material, wherein the edible biodegradable dough 30 is actuated by a roller systematically to move or stop in a same direction;

B) cutting, wherein when the edible biodegradable dough 30 is moved between the first cutting mold 11 and the second cutting mold 12 of the cutting assembly 10, the cutting portion 111 of the first cutting mold 11 of the cutting assembly 10 moves to the multiple grooves 121 of the second cutting mold 12 so as to be cut to produce at least one dough tableware Y, wherein the at least one dough tableware Y drops to the molding cavity 222 of the second receiving mold 22 of the holding assembly 20 via the multiple grooves 121 of the second cutting mold 12, the first cutting mold 11 of cutting mold 10 moves back to an original position upwardly, the second receiving mold 22 of the holding assembly 20 moves forward with the delivery equipment, and the edible biodegradable dough 30 moves forward;

C) pressing, wherein the second receiving mold 22 of the holding assembly 20 mates with the delivery equipment to moveably locate below the multiple pressing portions 211 of the first receiving mold 21 so that the multiple pressing portions 211 of the first receiving mold 21 presses the second receiving mold 22, such that the at least one dough tableware Y is pressed in the molding cavity 222 of the second receiving mold 22; and

D) repeating, the first receiving mold 21 moves back to an original position upward after pressing the second receiving mold 22, the second receiving mold 22 matches with the delivery equipment to move forward, and the edible biodegradable dough 30 moves forward, wherein the steps A), B), and C) are executed repeatedly to obtain the automated cutting die being produced edible biodegradable tableware.

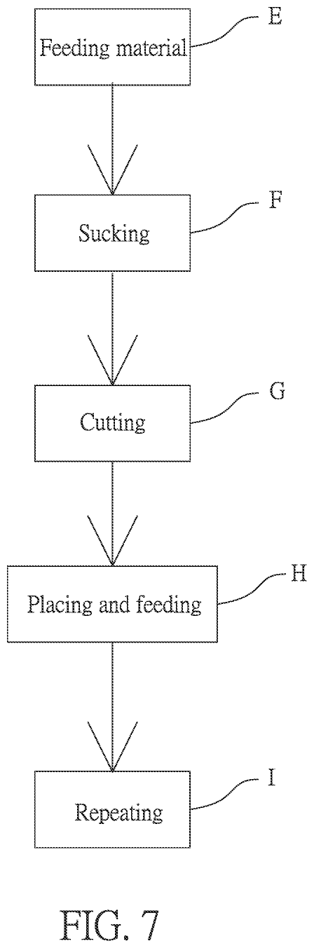

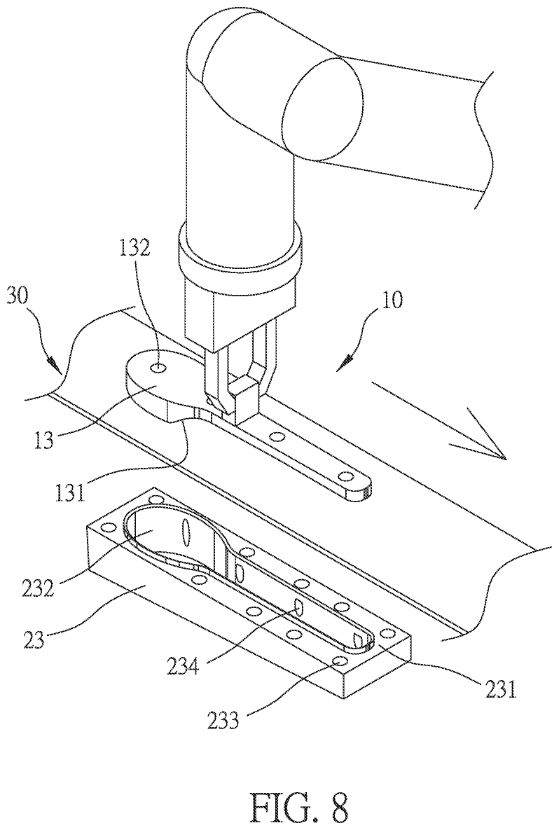

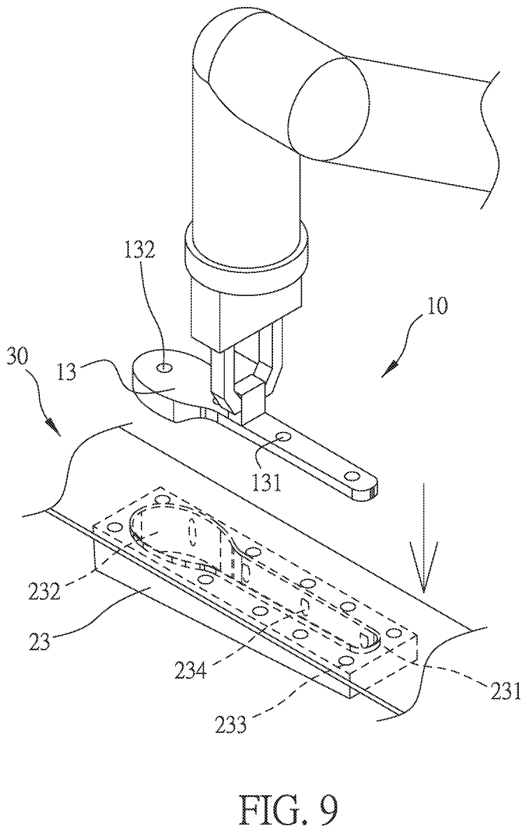

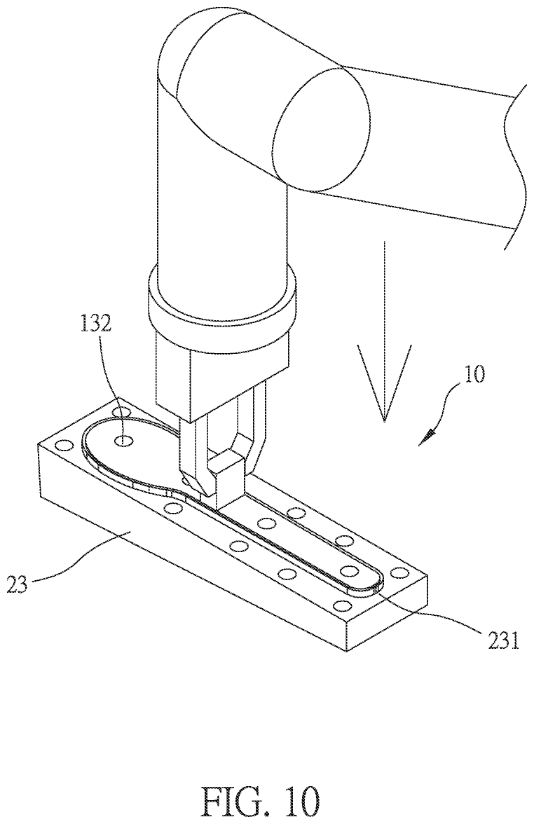

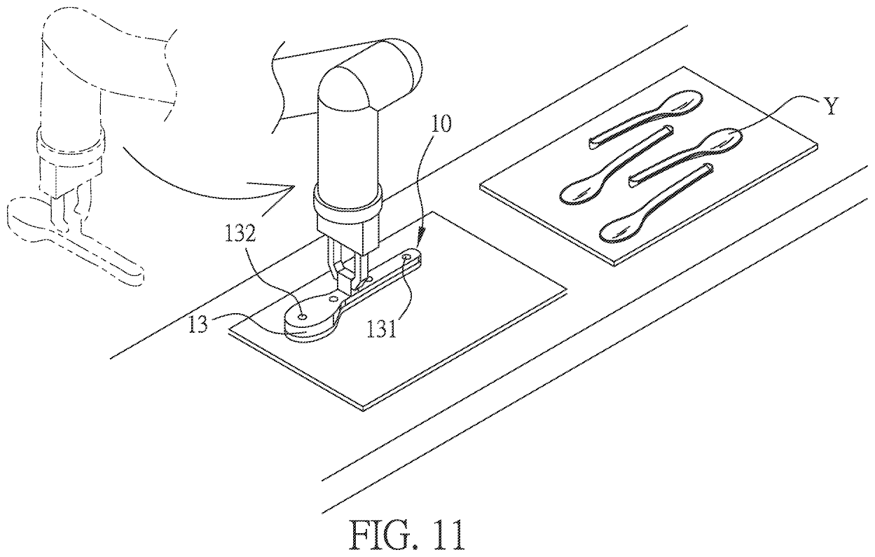

Referring to FIGS. 7-11, the automated cutting die being produced edible biodegradable automated tableware of a first embodiment comprises: a cutting assembly 10, a holding assembly 20, and edible biodegradable dough 30.

The cutting assembly 10 includes a cutting mold 13, and the cutting mold 13 has a cutting unit 131 formed on a first surface thereof in a tableware shape, such as a knife, a fork, or a soup spoon, and a second surface of the cutting mold 13 is locked by a mechanical arm, wherein the cutting mold 13 also has multiple vacuum suction holes 132 defined thereon.

The holding assembly 20 includes a second receiving mold 23, and the second receiving mold 23 has a surround portion 231 and a molding cavity 232 corresponding to the cutting unit 131 of the cutting mold 13, wherein the surround portion 231 has multiple vacuum sucking apertures 233 defined thereon, and the molding cavity 232 has multiple jet orifices 234 formed therein.

As shown in FIG. 7, a method of operating the automated cutting die comprises steps of:

E) feeding material, wherein the edible biodegradable dough 30 is actuated by a roller systematically to move or stop in a same direction;

F) sucking, wherein when the multiple vacuum sucking apertures 233 of the second receiving mold 23 of the holding assembly 20 suck the edible biodegradable dough 30, the roller stops actuating the edible biodegradable dough 30 to move;

G) cutting, wherein the cutting mold 13 of the cutting assembly 10 locked on a mechanical arm corresponds to and locates above the second receiving mold 23 of the holding assembly 20, and the cutting mold 13 of the cutting assembly 10 is moved upward and downward by the mechanical arm, wherein when the multiple vacuum sucking apertures 233 suck the edible biodegradable dough 30, the roller stops actuating the edible biodegradable dough 30 to move, and the mechanical arm moves the cutting mold 13 to the second receiving mold 23 of the holding assembly 20 so as to cut the edible biodegradable dough 30 to form the at least one dough tableware Y, and the multiple jet orifices 234 in the molding cavity 232 of the second receiving mold 23 of the holding assembly 20 spay the at least one dough tableware Y toward the cutting mold 13 of the cutting assembly 10 so that the multiple vacuum suction holes 132 of the cutting mold 13 of the cutting assembly 10 suck the at least one dough tableware Y;

H) placing and feeding, wherein the mechanical arm moves the cutting mold 13 of the cutting assembly 10 to a forming mold production line parallelly; and

I) repeating, wherein the second receiving mold 23 of the holding mold 20 mates with the delivery equipment to move forward after pressing, and the edible biodegradable dough 30 is moved forward, wherein the steps of E), F), G), and H) are executed repeatedly, thus producing the automated cutting die.

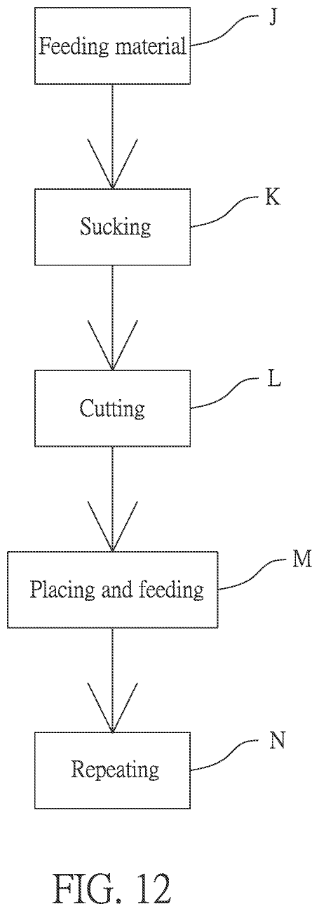

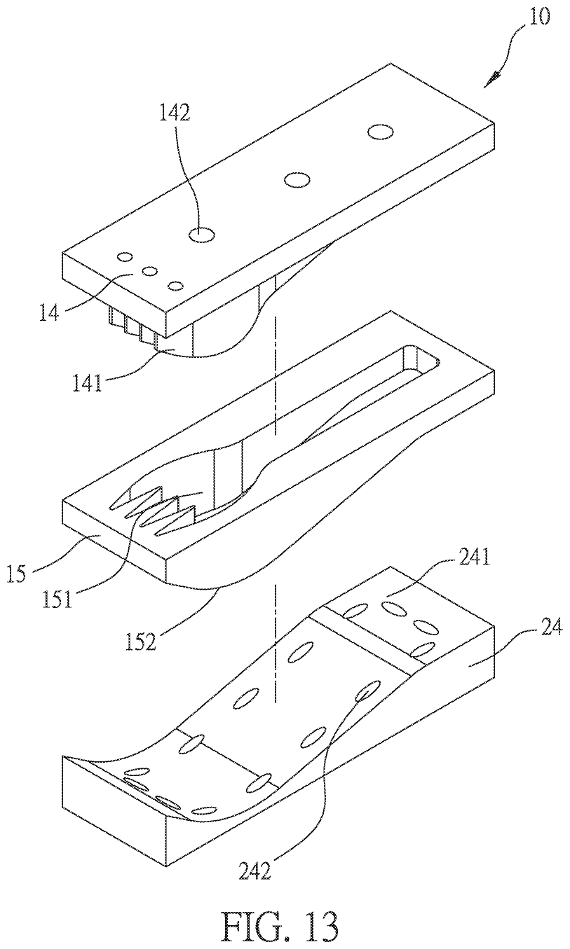

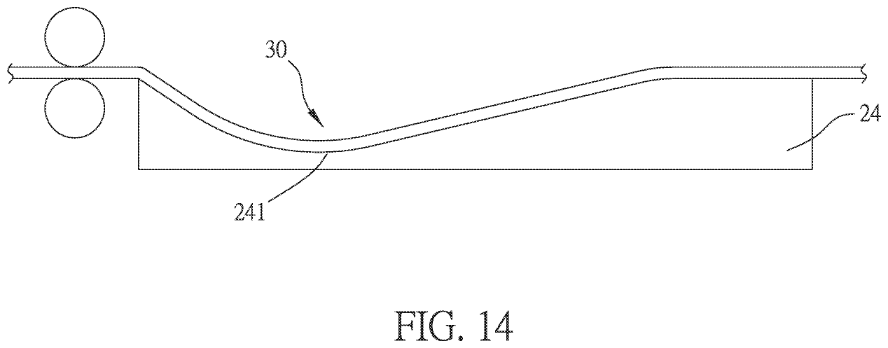

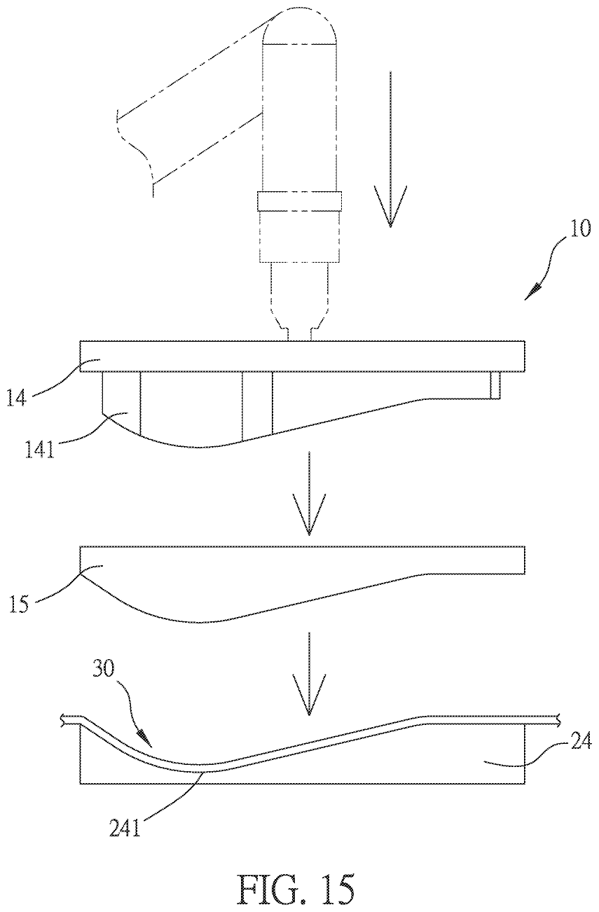

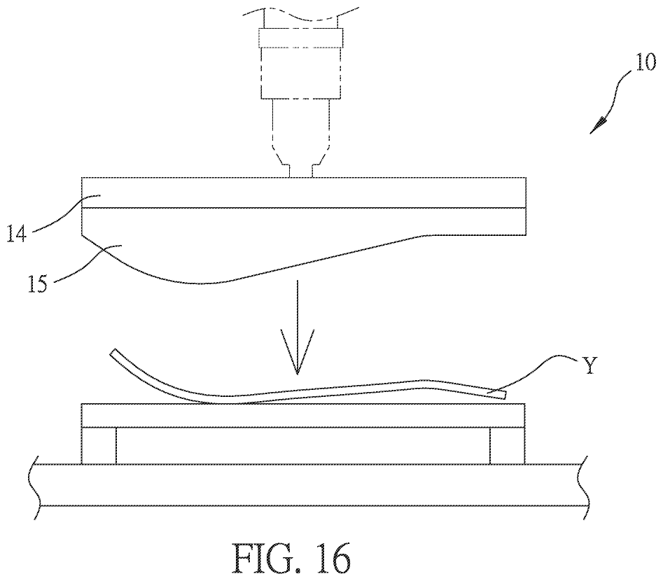

With reference to FIGS. 12-16, in a second embodiment, an automated cutting die comprises: a cutting assembly 10, a holding assembly 20, and edible biodegradable dough 30.

The cutting assembly 10 includes a first cutting unit 14 and a second cutting unit 15, a first end of the first cutting unit 14 is fixed on equipment, and the first cutting unit 14 has a cutting protrusion 141 formed on a second end thereof in a tableware shape, such as a knife, a fork, or a soup spoon, and the first cutting unit 14 has multiple vacuum suction apertures 142, wherein the second cutting unit 15 has multiple grooves 151 defined on a middle section thereof and corresponding to the cutting protrusion 141 of the first cutting unit 14, and the second cutting unit 15 also has a wavy contacting face 152 formed on an end surface thereof away from the first cutting unit 14.

The holding assembly 20 includes a second receiving mold 24, the second receiving mold 24 has a wavy abutting portion 241 corresponding to the wavy contacting face 152 of the second cutting unit 15, wherein the wavy abutting portion 241 has the multiple vacuum sucking orifices 242 and the multiple jet orifices 243 defined thereon.

Referring to FIG. 12, a method of operating the automated cutting die comprises steps of:

J) feeding material, wherein the edible biodegradable dough 30 is actuated by a roller systematically to move or stop in a same direction, and the edible biodegradable dough 30 is loose after stopping movement;

K) sucking, wherein multiple vacuum sucking orifices 242 of the wavy abutting portion 241 suck the edible biodegradable dough 30, when the edible biodegradable dough 30 moves to locate above the second receiving mold 24, such that the edible biodegradable dough 30 matingly contacts with the wavy abutting portion 241 of the second receiving mold 24 when stopping the movement;

L) cutting, wherein a mechanical arm is connected with the second cutting unit 14 of the cutting assembly 102, the cutting protrusion 141 of the first cutting unit 14 correspond to the multiple grooves 151 of the second cutting unit 15, and the holding assembly 20 includes a second receiving mold 24, wherein the mechanical arm actuates the first cutting unit 14 of the cutting assembly 102 to move upward and downward, the multiple vacuum sucking orifices 242 of the wavy abutting portion 241 suck the edible biodegradable dough 30 tightly, the edible biodegradable dough 30 stops the movement, and the cutting protrusion 141 of the first cutting unit 14 is configured to force the multiple grooves 151 of the second cutting unit 15 to face a second receiving mold 24 of the holding assembly 20 so as to cut the edible biodegradable dough 30 in the at least one dough tableware Y, and the multiple vacuum suction apertures 142 of the first cutting unit 14 suck the at least one dough tableware Y;

M) placing and feeding, wherein the mechanical arm sucks and moves the first cutting unit 14 of the at least one dough tableware Y to a forming mold production line parallelly; and

N) repeating, wherein a delivery equipment is configured to move the edible biodegradable dough 30 forward, and the steps of J), K), L), and M) are executed repeatedly, thus producing the automated cutting die.

While various embodiments in accordance with the present invention have been shown and described, it is clear to those skilled in the art that further embodiments may be made without departing from the scope of the present invention.

What is claimed is:

1. An automated cutting die being produced edible biodegradable tableware comprising: a cutting assembly, a holding assembly, and edible biodegradable dough;
wherein the cutting assembly includes a first cutting mold and a second cutting mold, wherein a first end of the first cutting mold is arranged on equipment, and the first cutting mold has multiple cutting portions formed on a second end thereof, the second cutting mold has multiple grooves defined on a middle section thereof and corresponding to the multiple cutting portions of the first cutting mold, and the second cutting mold has two first support portions formed beside the multiple grooves and being fixed on the equipment;
wherein the holding assembly includes a first receiving mold and a second receiving mold, the first receiving mold has multiple pressing portions corresponding to the multiple grooves of the second cutting mold, two second support portions formed beside the multiple pressing portions, and multiple through holes defined on the multiple pressing portions, wherein the second receiving mold has a recessed portion defined thereon, a molding cavity formed in a hollow shape beside the recessed portion and multiple passing orifices defined on the molding cavity.

2. The automated cutting die as claimed in claim 1, wherein a method of operating the automated cutting die comprises steps of:
A) feeding material, wherein the edible biodegradable dough is actuated by a roller systematically to move or stop in a same direction;
B) cutting, wherein when the edible biodegradable dough is moved between the first cutting mold and the second cutting mold of the cutting assembly, the cutting portion of the first cutting mold of the cutting assembly moves to the multiple grooves of the second cutting mold so as to be cut to produce at least one dough tableware, wherein the at least one dough tableware drops to the molding cavity of the second receiving mold of the holding assembly via the multiple grooves of the second cutting mold, the first cutting mold of cutting mold moves back to an original position upwardly, the second receiving mold of the holding assembly moves forward with the delivery equipment, and the edible biodegradable dough moves forward;
C) pressing, wherein the second receiving mold of the holding assembly mates with the delivery equipment to moveably locate below the multiple pressing portions of the first receiving mold so that the multiple pressing portions of the first receiving mold presses the second receiving mold, such that the at least one dough tableware is pressed in the molding cavity of the second receiving mold; and
D) repeating, the first receiving mold moves back to an original position upward after pressing the second receiving mold, the second receiving mold matches with the delivery equipment to move forward, and the edible biodegradable dough moves forward, wherein the steps A), B), and C) are executed repeatedly to obtain the automated cutting die being produced edible biodegradable tableware.

3. The automated cutting die as claimed in claim 1, wherein the multiple cutting portions are formed in a tableware shape, and the tableware shape is any one of a knife, a fork, and a soup spoon.

4. An automated cutting die being produced edible biodegradable tableware comprising: a cutting assembly, a holding assembly, and edible biodegradable dough;
wherein the cutting assembly includes a cutting mold, and the cutting mold has a cutting unit formed on a first surface thereof, wherein a second surface of the cutting mold is locked by a mechanical arm, and the cutting mold also has multiple vacuum suction holes defined thereon; and
wherein the holding assembly includes a second receiving mold, and the second receiving mold has a surround portion and a molding cavity corresponding to the cutting unit of the cutting mold, wherein the surround portion has multiple vacuum sucking apertures defined thereon, and the molding cavity has multiple jet orifices formed therein.

5. The automated cutting die as claimed in claim 4, wherein a method of operating the automated cutting die comprises steps of:
E) feeding material, wherein the edible biodegradable dough is actuated by a roller systematically to move or stop in a same direction;
F) sucking, wherein when the multiple vacuum sucking apertures of the second receiving mold of the holding assembly suck the edible biodegradable dough, the roller stops actuating the edible biodegradable dough to move;
G) cutting, wherein the cutting mold of the cutting assembly locked on a mechanical arm corresponds to and locates above the second receiving mold of the holding assembly, and the cutting mold of the cutting assembly is moved upward and downward by the mechanical arm, wherein when the multiple vacuum sucking apertures suck the edible biodegradable dough, the roller stops actuating the edible biodegradable dough to move, and the mechanical arm moves the cutting mold to the second receiving mold of the holding assembly so as to cut the edible biodegradable dough to form the at least one dough tableware, and the multiple jet orifices in the molding cavity of the second receiving mold of the holding assembly spay the at least one dough tableware toward the cutting mold of the cutting assembly so that the multiple vacuum suction holes of the cutting mold of the cutting assembly suck the at least one dough tableware;
H) placing and feeding, wherein the mechanical arm moves the cutting mold of the cutting assembly to a forming mold production line parallelly; and
I) repeating, wherein the second receiving mold of the holding mold mates with the delivery equipment to move forward after pressing, and the edible biodegradable dough is moved forward, wherein the steps of E), F), G), and H) are executed repeatedly, thus producing the automated cutting die.

6. The automated cutting die as claimed in claim 4, wherein the cutting unit is formed in a tableware shape, and the tableware shape is any one of a knife, a fork, and a soup spoon.

7. An automated cutting die being produced edible biodegradable tableware comprising: a cutting assembly, a holding assembly, and edible biodegradable dough;
wherein the cutting assembly includes a first cutting unit and a second cutting unit, a first end of the first cutting unit is fixed on equipment, and the second cutting unit has a cutting protrusion formed on a second end thereof, and the second cutting unit has multiple vacuum suction apertures, wherein the second cutting unit has multiple grooves defined on a middle section thereof and corresponding to the cutting protrusion of the first cutting unit, and the second cutting unit also has a wavy contacting face formed on an end surface thereof away from the first cutting unit;
wherein the holding assembly includes a second receiving mold, the second receiving mold has a wavy abutting portion corresponding to the wavy contacting face of the second cutting unit, and the wavy abutting portion has multiple vacuum sucking orifices and the multiple jet orifices defined thereon.

8. The automated cutting die as claimed in claim 7, wherein the cutting protrusion are formed in a tableware shape, and the tableware shape is any one of a knife, a fork, and a soup spoon.

9. The automated cutting die as claimed in claim 7, wherein a method of operating the automated cutting die comprises steps of:
J) feeding material, wherein the edible biodegradable dough is actuated by a roller systematically to move or stop in a same direction, and the edible biodegradable dough is loose after stopping movement;
K) sucking, wherein the multiple vacuum sucking orifices of the wavy abutting portion suck the edible biodegradable dough, when the edible biodegradable dough moves to locate above the second receiving mold, such that the edible biodegradable dough matingly contacts with the wavy abutting portion of the second receiving mold when stopping the movement;
L) cutting, wherein a mechanical arm is connected with the second cutting unit of the cutting assembly, the cutting protrusion of the first cutting unit correspond to the multiple grooves of the second cutting unit, and the holding assembly includes a second receiving mold, wherein the mechanical arm actuates the first cutting unit of the cutting assembly to move upward and downward, the multiple vacuum sucking orifices of the wavy abutting portion suck the edible biodegradable dough tightly, the edible biodegradable dough stops the movement, and the cutting protrusion of the first cutting unit is configured to force the multiple grooves of the second cutting unit to face a second receiving mold of the holding assembly so as to cut the edible biodegradable dough in the at least one dough tableware, and the multiple vacuum suction apertures of the first cutting unit suck the at least one dough tableware;
M) placing and feeding, wherein the mechanical arm sucks and moves the first cutting unit of the at least one dough tableware to a forming mold production line parallelly; and
N) repeating, wherein a delivery equipment is configured to move the edible biodegradable dough forward, and the steps of J), K), L), and M) are executed repeatedly, thus producing the automated cutting die.
